(19) United States
(12) Patent Application Publication
(10) Pub. No.: US 2025/0112500 A1
(43) Pub. Date: Apr. 3, 2025

(54) NOVEL SHAFT EMBEDDED CONTACTLESS POWER TRANSFER FOR A SEPARATELY EXCITED MACHINE

(71) Applicant: GM GLOBAL TECHNOLOGY OPERATIONS LLC, Detroit, MI (US)

(72) Inventors: Muhammad A. Zahid, Troy, MI (US); Khorshed Mohammed Alam, Canton, MI (US); Mazharul Chowdhury, Canton, MI (US); Junghoon Kim, Springboro, OH (US); Yilun Luo, Ann Arbor, MI (US)

(73) Assignee: GM GLOBAL TECHNOLOGY OPERATIONS LLC, Detroit, MI (US)

(21) Appl. No.: 18/480,085

(22) Filed: Oct. 3, 2023

(51) Int. Cl. H02J 50/10; B60L 53/12; B60L 53/20; H01F 27/06; H01F 27/08; H01F 27/24; H01F 27/28

(52) U.S. Cl. CPC H02J 50/10; B60L 53/12; B60L 53/20; H01F 27/06; H01F 27/08; H01F 27/24; H01F 27/28; B60L 2210/30

(57) ABSTRACT

A power transfer system may include a rotating magnetic core; a rotating high index core winding within the rotating magnetic core; a stationary high index core winding within the rotating high index core winding; and a stator referenced magnetic core within the stationary high index core winding. The power transfer system may include a rotor rectifier mounting plate, operatively attached to the rotating magnetic core, and/or a first and a second stationary high index core winding; and/or the stationary high index core winding and the stator referenced magnetic core do not rotate and/or the rotor rectifier mounting plate includes rectifiers to convert AC to DC; and/or the rotor rectifier mounting plate is further configured as a heat sink; and/or the rotor rectifier mounting plate is operatively attached to the rotating magnetic core via adhesive; and/or cooling fluid is allowed to pass through the power transfer system.

### INTRODUCTION

The present disclosure relates to contactless power transfer for separately excited machines. Currently, no technologies exist to use a contactless power transfer mechanism for a separately excited machine.

### SUMMARY

A power transfer system for a separately excited machine, includes a rotating magnetic core; a rotating high index core winding radially within the rotating magnetic core; a stationary high index core winding radially within the rotating high index core winding; and a stator referenced magnetic core radially within the stationary high index core winding. The power transfer system may include a rotor rectifier mounting plate, operatively attached to the rotating magnetic core. The stationary high index core winding may includes a first stationary high index core winding and a second stationary high index core winding.

The stationary high index core winding and the stator referenced magnetic core do not rotate. The rotor rectifier mounting plate may include rectifiers to convert AC to DC, which are operatively attached to the rotating high index core winding, and the mounting plate may be further configured as a heat sink. The rotor rectifier mounting plate may be operatively attached to the rotating magnetic core via adhesive. The power transfer system may be configured to allow cooling fluid to pass therethrough.

A vehicle having a contactless power transfer mechanism for a separately excited machine, including a rotating magnetic core; a rotating high index core winding within the rotating magnetic core; a stationary high index core winding within the rotating high index core winding; and a stator referenced magnetic core within the stationary high index core winding. The stationary high index core winding and the stator referenced magnetic core do not rotate.

A rotor rectifier is operatively attached to the rotating magnetic core and includes a mounting plate; one or more rectifiers; and a second plate. The one or more rectifiers are between the mounting plate and the second plate. Cooling fluid is allowed to pass through the contactless power transfer mechanism and the mounting plate and the second plate may have holes to promote cooling.

The one or more rectifiers may be configured to convert AC to DC and mounting plate may be configured as a heat sink. The mounting plate may be operatively attached to the rotating magnetic core via an adhesive. The stationary high index core winding may include a first stationary high index core winding and a second stationary high index core winding.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic top isometric view of a contactless power transfer mechanism for separately excited machines.

FIG. 2 is a schematic bottom isometric view of a contactless power transfer mechanism.

FIG. 3 is a schematic exploded view of a contactless power transfer mechanism.

FIG. 4 is a schematic side view of a contactless power transfer mechanism.

FIG. 5 is a schematic top view of a contactless power transfer mechanism showing cross-section lines.

FIG. 6 is a schematic top view of a contactless power transfer mechanism.

FIG. 7 is a schematic bottom view of a contactless power transfer mechanism.

FIG. 8 is a schematic cross-sectional view of a contactless power transfer mechanism taken along line A-A of FIG. 5.

FIG. 9 is a schematic cross-sectional view of a contactless power transfer mechanism taken along line B-B of FIG. 5.

### DETAILED DESCRIPTION

Referring to the drawings, like reference numbers refer to similar components, wherever possible. In general, a separately excited machine is one where the field winding or coil is energized by a separate or external source. The flux produced by the poles depends upon the field current with the unsaturated region of magnetic material of the poles—i.e., flux is directly proportional to the field current—but in the saturated region, the flux remains constant.

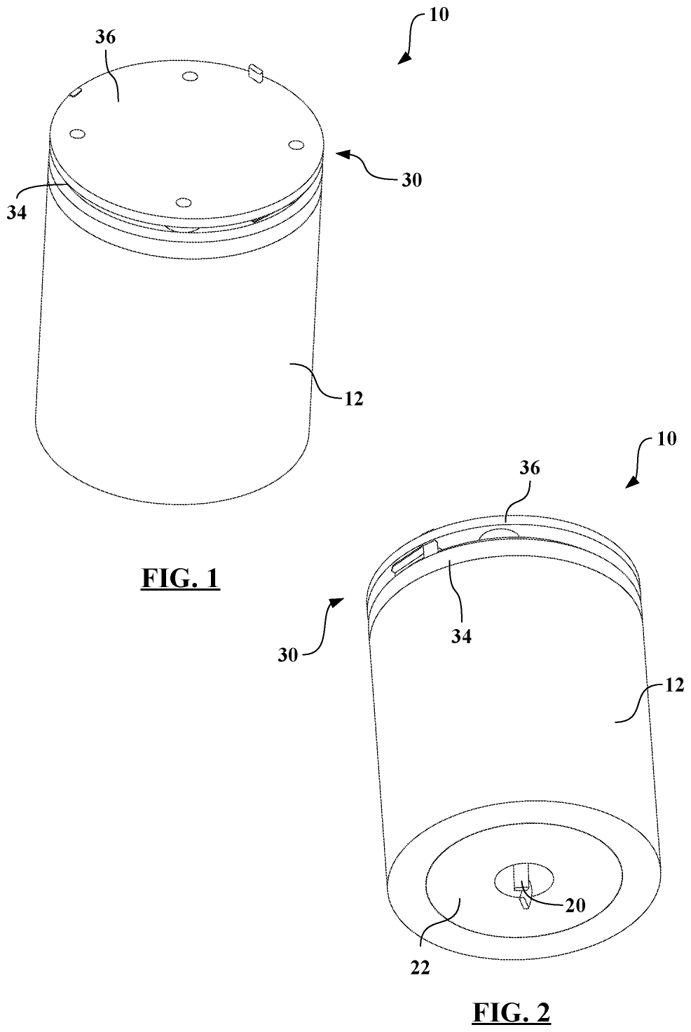

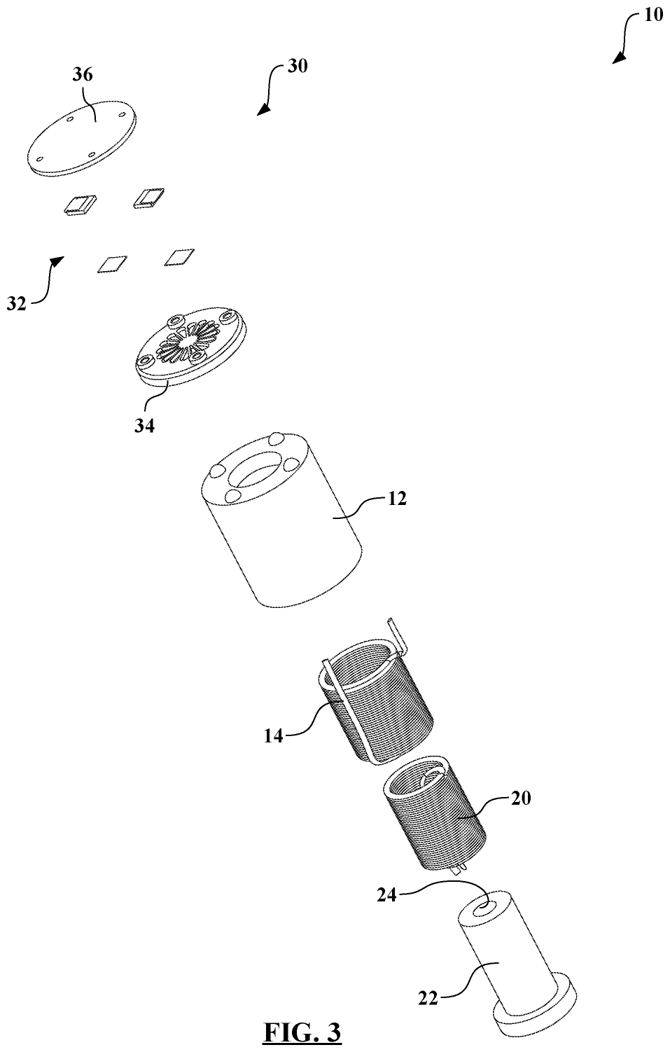

FIG. 1 is a schematic top isometric view of a contactless power transfer mechanism 10 and FIG. 2 is a schematic bottom isometric view of the contactless power transfer mechanism 10. FIG. 3 is a schematic exploded view of the contactless power transfer mechanism 10.

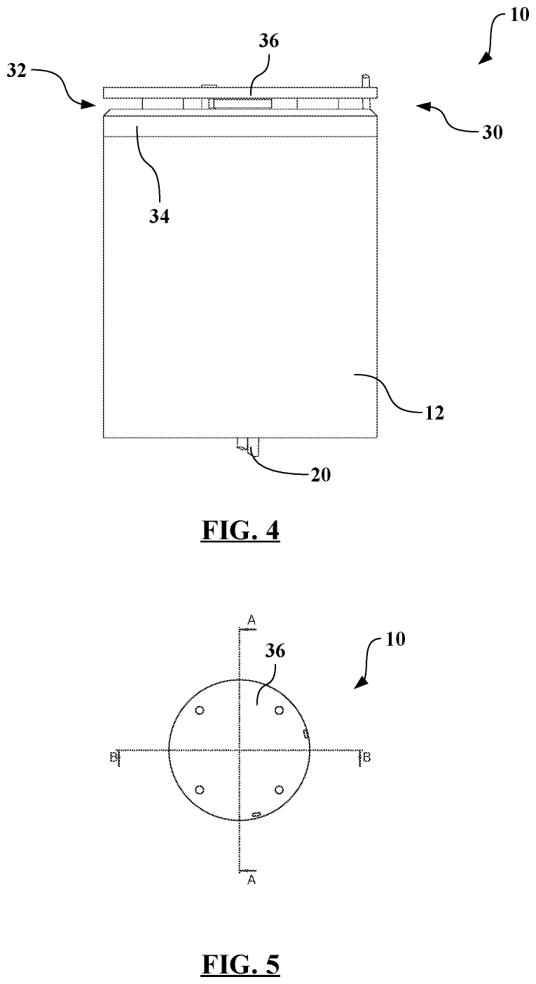

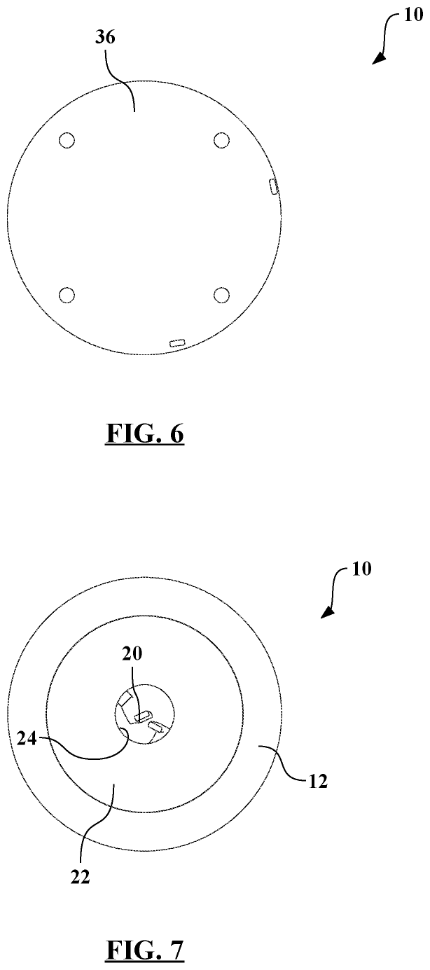

The remaining figures illustrate various views of the contactless power transfer mechanism 10. FIG. 4 is a schematic side view of the contactless power transfer mechanism 10. FIG. 6 is a schematic top view of the contactless power transfer mechanism 10 and FIG. 7 is a schematic bottom view of the contactless power transfer mechanism 10.

The drawings and figures presented herein are diagrams, are not to scale, and are provided purely for descriptive purposes. Thus, any specific or relative dimensions or alignments shown in the drawings are not to be construed as limiting. While the disclosure may be illustrated with respect to specific applications or industries, those skilled in the art will recognize the broader applicability of the disclosure. Those having ordinary skill in the art will recognize that terms such as “above,” “below,” “upward,” “downward,” et cetera, are used descriptively of the figures, and do not represent limitations on the scope of the disclosure, as defined by the appended claims. Any numerical designations, such as “first” or “second” are illustrative only and are not intended to limit the scope of the disclosure in any way.

Features shown in one figure may be combined with, substituted for, or modified by, features shown in any of the figures. Unless stated otherwise, no features, elements, or limitations are mutually exclusive of any other features, elements, or limitations. Furthermore, no features, elements, or limitations are absolutely required for operation. Any specific configurations shown in the figures are illustrative only and the specific configurations shown are not limiting of the claims or the description.

The term vehicle is broadly applied to any moving platform. Vehicles into which the disclosure may be incorporated include, for example and without limitation: passenger or freight vehicles; autonomous driving vehicles; industrial, construction, and mining equipment; and various types of aircraft.

All numerical values of parameters (e.g., of quantities or conditions) in this specification, including the appended claims, are to be understood as being modified in all instances by the term “about,” whether or not the term actually appears before the numerical value. About indicates that the stated numerical value allows some slight imprecision (with some approach to exactness in the value; about or reasonably close to the value; nearly). If the imprecision provided by about is not otherwise understood in the art with this ordinary meaning, then about as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiments.

When used herein, the term “substantially” often refers to relationships that are ideally perfect or complete, but where manufacturing realities prevent absolute perfection. Therefore, substantially denotes typical variance from perfection. For example, if height A is substantially equal to height B, it may be preferred that the two heights are 100.0% equivalent, but manufacturing realities likely result in the distances varying from such perfection. Skilled artisans will recognize the amount of acceptable variance. For example, and without limitation, coverages, areas, or distances may generally be within 10% of perfection for substantial equivalence. Similarly, relative alignments, such as parallel or perpendicular, may generally be considered to be within 5%.

A generalized control system, computing system, or controller is operatively in communication with relevant components of all systems, and recognizable by those having ordinary skill in the art. The controller includes, for example and without limitation, a non-generalized, electronic control device having a preprogrammed digital computer or processor, a memory, storage, or non-transitory computer-readable storage medium used to store data such as control logic, instructions, lookup tables, etc., and a plurality of input/output peripherals, ports, or communication protocols.

Furthermore, the controller may include, or be in communication with, a plurality of sensors. The controller is configured to execute or implement all control logic or instructions described herein and may be communicating with any sensors described herein or recognizable by skilled artisans. Any of methods described herein may be executed by one or more controllers.

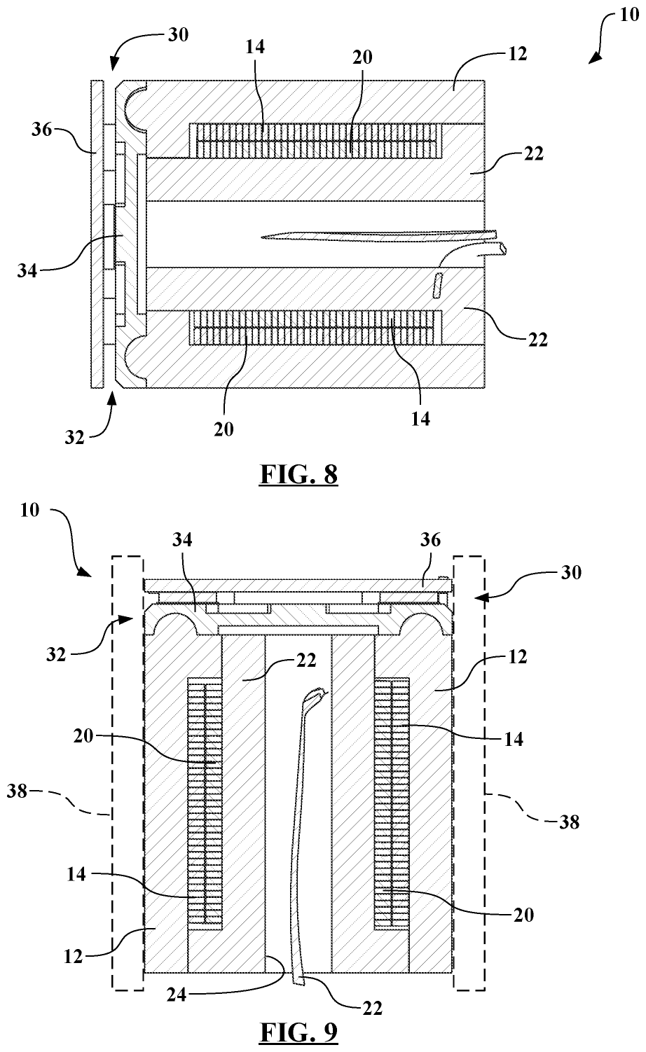

As best illustrated in FIG. 3, and, also in FIG. 8 which is a schematic cross-sectional view of the contactless power transfer mechanism 10 taken along line A-A of FIG. 5, and FIG. 9 is a schematic cross-sectional view of the contactless power transfer mechanism 10 taken along line B-B of FIG. 5. The contactless power transfer mechanism 10 includes a rotating magnetic core 12 and a rotating high index core winding 14 radially within the rotating magnetic core 12. The contactless power transfer mechanism 10 also includes a stationary high index core winding 20 radially within the rotating high index core winding 14 and a stator referenced magnetic core 22 radially within the stationary high index core winding 20.

Although difficult to see in FIGS. 8 and 9, there is an air gap between the rotating high index core winding 14 and the stationary high index core winding 20. Additionally, there is an air gap between the rotating magnetic core 12 and the stator referenced magnetic core 22. Note that cooling fluid, not shown or numbered, is allowed to pass through the contactless power transfer mechanism 10, particularly through a hole 24 within the stator referenced magnetic core 22. This allows passive cooling of the contactless power transfer mechanism 10 via hole 24. Note that passive cooling may be optional.

Generally, only the outer windings, the rotating high index core winding 14, experience centripetal forces in the outward direction as they will be rotating at high speeds. By utilizing high index wire each turn is supported by the outer core material, the rotating magnetic core 12. Note that the entire contactless power transfer mechanism 10 may be press fitted into a hollow shaft 38, shown highly schematically in FIG. 9.

The contactless power transfer mechanism 10 also includes a rotor rectifier mounting plate 30 that is operatively attached to the rotating magnetic core 12. The rotor rectifier mounting plate 30 includes rectifiers 32 to convert AC to DC. The rotor rectifier mounting plate 30 also includes a mounting plate 34, which may also serve as a heat sink, and a second plate 36 that may cover the rectifiers 32.

The rectifiers 32 may be operatively attached to the rotating high index core winding 14, and may be soldered to either the mounting plate 34 or the second plate 36. Note that in some configurations, there may also be a hole through the rotor rectifier mounting plate 30 and the second plate 36, but this alternative is not illustrated in the figures, such that passive fluid is cooling the rectifiers 32 is also promoted.

The stationary high index core winding 20 may be separated into two different windings, not separately numbered. This will allow the contactless power transfer mechanism 10 to utilize two separate rotor windings, on the stator referenced magnetic core 22, to allow for decoupled field excitations and fault tolerant operation. These windings sets, which may be referred to as first and second, are isolated from each other to, generally, limit any interference. The first winding set may be generally separated from the second winding set, or they may be interleaved together with alternating windings.

Note that the stationary high index core winding 20 and the stator referenced magnetic core 22 do not rotate. In some configurations, the rotor rectifier mounting plate 30 is operatively attached to the rotating magnetic core 12 via adhesive (not shown in the figures). Those having ordinary skill in the art will recognize suitable adhesives that can withstand the heat generated by the contactless power transfer mechanism 10. Furthermore, note that the adhesive may be an excellent conductor of heat to allow heat from the rectifiers 32—printed circuit board (PCB), which includes diodes—act as heat sink to be dissipated to the remainder of the contactless power transfer mechanism 10, and elsewhere.

Among the benefits of the contactless power transfer mechanism 10, are, without limitation: reducing the need for axial length increase due to rotor power transfer required for a separately excited machine; higher speed operation; optimize power electronic heat rejection and dissipation using PCB carrier and transformer core material to conduct heat to the larger drive unit housing; power transfer is placed inside the hollow shaft and the shaft acts as a shield to mitigate the external electromagnetic interference (EMI); remove the need for a dry environment to house the rotor power transfer and additional components such as sealed bearings; saves cost, by removing wear items such as brushes for rotor power transfer; and/or reduce the risk of producing brush wear debris and frictional losses due to moving interface contact and contact loss arcing.

The detailed description and the drawings or figures are supportive and descriptive of the subject matter herein. While some of the best modes and other embodiments have been described in detail, various alternative designs, embodiments, and configurations exist.

Furthermore, any examples shown in the drawings, or the characteristics of various examples mentioned in the present description, are not necessarily to be understood as examples independent of each other. Rather, it is possible that each of the characteristics described in one of the examples of an embodiment can be combined with one or a plurality of other desired characteristics from other examples, resulting in other examples not described in words or by reference to the drawings. Accordingly, such other examples fall within the framework of the scope of the appended claims.

1. A power transfer system for a separately excited machine, comprising:
a rotating magnetic core;
a rotating high index core winding radially within the rotating magnetic core;
a stationary high index core winding radially within the rotating high index core winding; and
a stator referenced magnetic core radially within the stationary high index core winding.

2. The power transfer system of claim 1, further comprising:
a rotor rectifier mounting plate, operatively attached to the rotating magnetic core.

3. The power transfer system of claim 2, wherein the stationary high index core winding further includes:
a first stationary high index core winding; and
a second stationary high index core winding.

4. The power transfer system of claim 3, wherein the stationary high index core winding and the stator referenced magnetic core do not rotate.

5. The power transfer system of claim 4, wherein the rotor rectifier mounting plate includes rectifiers to convert AC to DC, which are operatively attached to the rotating high index core winding.

6. The power transfer system of claim 4, wherein the rotor rectifier mounting plate is further configured as a heat sink.

7. The power transfer system of claim 6, wherein the rotor rectifier mounting plate is operatively attached to the rotating magnetic core via adhesive.

8. The power transfer system of claim 7, wherein the power transfer system is configured to allow cooling fluid to pass therethrough.

9. The power transfer system of claim 2, wherein the rotor rectifier mounting plate is further configured as a heat sink.

10. The power transfer system of claim 9, wherein the rotor rectifier mounting plate is operatively attached to the rotating magnetic core via adhesive.

11. The power transfer system of claim 2, wherein the rotor rectifier mounting plate includes rectifiers to convert AC to DC.

12. The power transfer system of claim 11, wherein the rotor rectifier mounting plate is further configured as a heat sink.

13. A vehicle having a contactless power transfer mechanism for a separately excited machine, comprising:
a rotating magnetic core;
a rotating high index core winding within the rotating magnetic core;
a stationary high index core winding within the rotating high index core winding; and
a stator referenced magnetic core within the stationary high index core winding, wherein the stationary high index core winding and the stator referenced magnetic core do not rotate;
a rotor rectifier, operatively attached to the rotating magnetic core, wherein the rotor rectifier further includes:
a mounting plate;
one or more rectifiers; and
a second plate, wherein the one or more rectifiers are between the mounting plate and the second plate,
wherein cooling fluid is allowed to pass through the contactless power transfer mechanism and the mounting plate and the second plate have include holes to promote cooling.

14. The vehicle having the contactless power transfer mechanism of claim 13, wherein the one or more rectifiers are configured to convert AC to DC.

15. The vehicle having the contactless power transfer mechanism of claim 14, wherein the mounting plate is further configured as a heat sink.

16. The vehicle having the contactless power transfer mechanism of claim 15, wherein the mounting plate is operatively attached to the rotating magnetic core via an adhesive.

17. The vehicle having the contactless power transfer mechanism of claim 16, wherein the stationary high index core winding further includes:
a first stationary high index core winding; and
a second stationary high index core winding.

18. The vehicle having the contactless power transfer mechanism of claim 13, wherein the stationary high index core winding further includes:
a first stationary high index core winding; and
a second stationary high index core winding.

19. The vehicle having the contactless power transfer mechanism of claim 18, wherein the mounting plate is further configured as a heat sink.

20. The vehicle having the contactless power transfer mechanism of claim 19, wherein the mounting plate is operatively attached to the rotating magnetic core via an adhesive.
